(19) United States
(12) Patent Application Publication
(10) Pub. No.: US 2026/0050800 A1
(43) Pub. Date: Feb. 19, 2026

(54) DIGITAL ASSISTANT EVALUATION

(71) Applicant: Beijing Zitiao Network Technology Co., Ltd., Beijing (CN)

(72) Inventors: Long YANG, Beijing (CN); Qinggan GOU, Beijing (CN)

(21) Appl. No.: 19/001,108

(22) Filed: Dec. 24, 2024

(30) Foreign Application Priority Data
Aug. 15, 2024 (CN) 202411126418.7

(51) Int. Cl. G06N 5/022; G06F 9/451

(52) U.S. Cl. CPC G06N 5/022; G06F 9/453

(57) ABSTRACT

The disclosure relates to digital assistant evaluation. In an example method, in response to an evaluation request for a target digital assistant, at least one set of test cases for the target digital assistant is obtained, and each set of test cases includes at least one test question related to a chat skill of the target digital assistant. The at least one set of test cases is provided to the target digital assistant to obtain a reply to the at least one set of test cases by the target digital assistant. A target evaluation index for the target digital assistant is determined based at least on the at least one set of test cases and the reply to the at least one set of test cases by the target digital assistant. A quality evaluation result of the target digital assistant is determined based on the target evaluation index.

### CROSS-REFERENCE

This application claims the priority to Chinese Patent Application No. 202411126418.7, filed on Aug. 15, 2024, entitled “Method, Apparatus, Device and Storage Medium for evaluating a digital assistant,” the entire content of which is incorporated herein by reference.

### TECHNICAL FIELD

Example embodiments of the present disclosure generally relate to the field of computers, and in particular, digital assistant evaluation.

### BACKGROUND

A digital assistant refers to a system or an application with a conversational capability. With the popularization of the digital assistant in the fields of customer service, education, entertainment and the like, the interaction quality of the digital assistant becomes increasingly important. Evaluation of the digital assistant has an important meaning to ensure its quality and performance. Through evaluation, the digital assistant that satisfies quality and performance requirements can be recommended to the users, thereby improving user experience and satisfaction. Therefore, how to accurately evaluate the digital assistant is particularly important.

### SUMMARY

In a first aspect of the present disclosure, a method for evaluating a digital assistant is provided. The method may include obtaining, in response to an evaluation request for a target digital assistant, at least one set of test cases for the target digital assistant, each set of test cases comprising at least one test question related to a chat skill of the target digital assistant. The at least one set of test cases is provided to the target digital assistant to obtain a reply to the at least one set of test cases by the target digital assistant. A target evaluation index for the target digital assistant is determined based at least on the at least one set of test cases and the reply to the at least one set of test cases by the target digital assistant, the target evaluation index comprising at least a first feature value indicating a chat skill score of the target digital assistant. A quality evaluation result of the target digital assistant is determined based on the target evaluation index.

In a second aspect of the present disclosure, an apparatus for evaluating a digital assistant is provided. The apparatus may include a test case obtaining module configured to obtain, in response to an evaluation request for a target digital assistant, at least one set of test cases for the target digital assistant, each set of test cases comprising at least one test question related to a chat skill of the target digital assistant; a reply obtaining module configured to provide the at least one set of test cases to the target digital assistant to obtain a reply to the at least one set of test cases by the target digital assistant; a target evaluation index determination module configured to determine a target evaluation index for the target digital assistant based at least on the at least one set of test cases and the reply to the at least one set of test cases by the target digital assistant, the target evaluation index comprising at least a first feature value indicating a chat skill score of the target digital assistant; a quality evaluation result determining module configured to determine a quality evaluation result of the target digital assistant based on the target evaluation index.

In a third aspect of the present disclosure, an electronic device is provided. The device comprises at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program, when executed by a processor, implements the method of the first aspect.

In a fifth aspect of the present disclosure, a computer program product or a computer program is provided. The computer program product or the computer program comprises computer instructions stored in a computer-readable storage medium. A processor of the computer device reads the computer instructions from the computer-readable storage medium, and the processor executes the computer instructions, to cause the computer device to perform the method provided in various optional modes in an aspect of the embodiments of the present application. In other words, the computer instructions, when executed by the processor, implement the method provided in an aspect of the embodiments of the present application.

It should be understood that the content described in this section is not intended to limit the key features or important features of the embodiments of the present disclosure, nor is it intended to limit the scope of the present disclosure. Other features of the present disclosure will become apparent from the following description.

### BRIEF DESCRIPTION OF DRAWINGS

The above and other features, advantages, and aspects of various embodiments of the present disclosure will become more apparent from the following detailed description in conjunction with the accompanying drawings. In the drawings, the same or similar reference signs refer to the same or similar elements, in which:

FIG. 1 illustrates a schematic diagram of an example environment in which embodiments of the present disclosure can be implemented;

FIG. 2 illustrates a flowchart of a method for evaluating a digital assistant according to some embodiments of the present disclosure;

FIG. 3 illustrates an example diagram of a chat skill score interface according to some embodiments of the present disclosure;

FIG. 4 illustrates a training flowchart of an evaluation model according to some embodiments of the present disclosure;

FIG. 5 illustrates an example diagram of a correlation distribution according to some embodiments of the present disclosure;

FIG. 6 illustrates a schematic structural block diagram of an apparatus for evaluating a digital assistant according to some embodiments of the present disclosure; and

FIG. 7 illustrates a block diagram of an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are illustrated in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and the embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “an embodiment” or “the embodiment” should be understood as “at least one embodiment”. The term “some embodiments” should be understood as “at least some of the embodiments”. Other explicit and implicit definitions may also be included below.

Herein, unless explicitly stated, “in response to A” performing a step is not intended that this step is performed immediately after “A”, but may include one or more intermediate steps.

It is to be understood that the data involved in the technical solution, including but not limited to the data itself, the obtaining, usage, storage or deletion of the data, should comply with the requirements of corresponding laws and regulations and relevant provisions.

It is to be understood that, before using the technical solutions disclosed in the various embodiments of the present disclosure, the related user shall be informed of the type, the scope of use, and use scenarios and so on of information involved in the present disclosure in an appropriate manner in accordance with relevant laws and regulations, and the related user's authorization shall be obtained. The related user may include any type of subject of rights, e.g. individuals, enterprises, organizations.

For example, in response to receiving an active request from a user, prompt information is sent to the related user to explicitly prompt the related user that an operation requested by the related user will require to obtain and use information of the related user, so that the related user can autonomously select, according to the prompt information, whether to provide the information to software or hardware, such as an electronic device, an application program, a server, or a storage medium that performs the operations of the technical solutions of the present disclosure.

As an optional but non-limiting implementation, in response to receiving an active request of the user, the prompt information is sent to the user, for example, in the form of a pop-up window, in which the prompt information may be presented in the form of text. In addition, the pop-up window may further carry a selection control for the user to select “agree” or “not agree” to provide the personal information to the electronic device.

It should be understood that the above process for notifying and obtaining the user's authorization is merely illustrative, and do not limit the implementations of the present disclosure, and other approaches that meet the relevant laws and regulations may also be applied to the implementations of the present disclosure.

As used herein, the term “model” may learn an association relationship between respective inputs and outputs from training data such that a corresponding output may be generated for a given input after training is done. Generation of the model may be based on machine learning techniques. Deep learning is a machine learning algorithm that processes inputs and provides corresponding outputs by using multiple layers of processing units. Neural network model is an example of the model based on deep learning. As used herein, the “model” may also be referred to as a “machine learning model,” “learning model,” “machine learning network,” or “learning network,” and these terms may be used interchangeably herein.

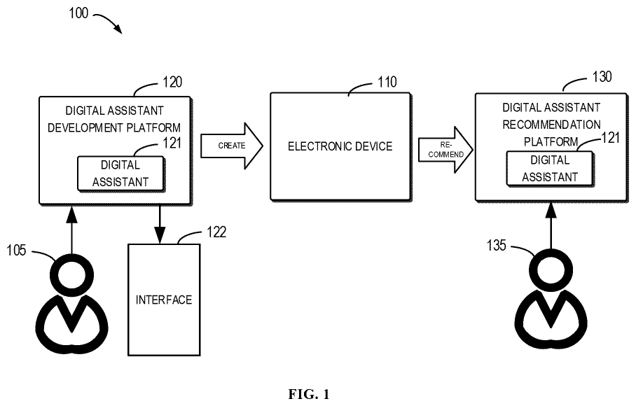

FIG. 1 illustrates a schematic diagram of the environment 100 in which embodiments of the present disclosure can be implemented. The digital assistant development platform 120 provides a creation and publishing environment of the digital assistant for the developer 105. For example, the digital assistant development platform 120 may provide various tools to the developer 105, such as prompt word information, plug-ins, workflows, knowledge bases, memory banks, voice, etc. In some embodiments, the digital assistant development platform 120 may be a low code platform that provides a tool kit for creating the digital assistant. The digital assistant development platform 120 may enable the visual development of the digital assistant, so that the developer 105 may skip the manual programming process, and accelerate the development cycle and cost of the application. The digital assistant development platform 120 may be any suitable platform that supports users to develop digital assistants and other types of applications, including for example an application platform-as-a-service (aPaaS) based platform. Such a platform can facilitate efficient development of applications by users, and implement operations such as application creation, application function adjustment, and so on.

The digital assistant development platform 120 may be deployed locally on a terminal device of the developer 105, and/or may be supported by a remote server. For example, the terminal device of the developer 105 may run a client of the digital assistant development platform 120, and the client may facilitate interaction between the user and the digital assistant development platform 120. In a case where the digital assistant development platform 120 runs on the terminal device of the user locally, the developer 105 may directly interact with the local digital assistant development platform 120 by using the client. In a case where the digital assistant development platform 120 runs on the server device, the server device may implement the provisioning of services to the client running in the terminal device based on the communication connection with the terminal device. The digital assistant development platform 120 may present a corresponding interface 122 to the developer 105 based on an operation of the developer 105 to output information to the developer 105 and/or receive information from the developer 105.

In some embodiments, the digital assistant development platform 120 may be associated to a corresponding database in which data or information required for the digital assistant creation process supported by the digital assistant development platform 120 is stored. For example, the database may store code and description information corresponding to various functional modules that compose the digital assistant. The digital assistant development platform 120 may also perform operations such as calling, adding, deleting, updating and the like on functional modules in the database. The database may also store operations executable on different functional blocks. For example, in a scenario in which a digital assistant is to be created, the digital assistant development platform 120 may call a corresponding functional block from the database to build the digital assistant.

In the embodiments of the present disclosure, the developer 105 may create the digital assistant 121 as needed on the digital assistant development platform 120 and publish the digital assistant 121. The digital assistant 121 may be published to any suitable application platform so long as the application platform can support the operation of the digital assistant 121. Upon publishing, the digital assistant 121 may be used for dialog interaction with the user 135.

After the digital assistant 121 is created/published, the digital assistant 121 may be evaluated by the electronic device 110 to obtain an evaluation result. For the digital assistant whose evaluation result satisfies a recommendation condition, the recommendation may be performed on a recommendation interface of the digital assistant recommendation platform 130. By way of example, the digital assistant recommendation platform 130 may be integrated in the electronic device 110, or may be a third-party platform independent of the electronic device 110. The evaluation of the digital assistant 121 by the electronic device 110 may be performed based on a plurality of dimensions, for example, an evaluation index corresponding to a chat skill, an evaluation index corresponding to a user feedback during interaction with the user 135, and the like.

The terminal device may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, comprising accessories and peripherals of these devices. In some embodiments, the electronic device 110 can also support any type of interface for a user (such as, a “wearable” circuit, and so on).

It should be understood that the structures and functions of various elements in the environment 100 are described for illustrative purposes only and do not imply any limitation to the scope of the present disclosure.

The traditional method for evaluating the digital assistant is mainly to execute recommendations after trial and testing by operators. This method relies on manual testing and evaluation, which ensures a certain level of quality but is less efficient and difficult to guarantee objectivity and consistency.

In embodiments of the present disclosure, a method for evaluating a digital assistant is provided. For a target digital assistant that is to be evaluated, at least one set of test cases for the target digital assistant is obtained, each set of test cases includes at least one test question related to a chat skill of the target digital assistant. The at least one set of test cases is provided to the target digital assistant to obtain a reply to the at least one set of test cases by the target digital assistant. A target evaluation index for the target digital assistant is determined based at least on the at least one set of test cases and the reply to the at least one set of test cases by the target digital assistant, the target evaluation index includes at least a first feature value indicating a chat skill score of the target digital assistant. A quality evaluation result of the target digital assistant is determined based on the target evaluation index.

Through the process described above, automated evaluation of the digital assistant can be implemented, so that a quality of the target digital assistant is evaluated at least from the perspective of the chat skills of the digital assistant. The automated evaluation method reduces reliance on manual testing, and makes the evaluation process more rapid, continuous and without interruptions. Operators no longer need to try and test each digital assistant individually, saving significant time and human resources. Moreover, the automatic test cases and the evaluation indexes ensure the standardization of the evaluation process, avoiding subjective deviation caused by individual differences, and ensuring the objectivity and consistency of the evaluation result. By using a plurality of sets of test cases, various functions and performances of the target digital assistant can be comprehensively evaluated, and a more detailed and accurate evaluation result is provided.

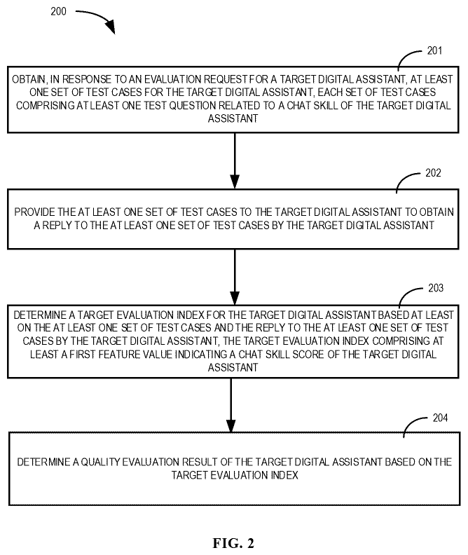

FIG. 2 illustrates an example process 200 of a method for evaluating a digital assistant according to some embodiments of the present disclosure. For ease of discussion, the process 200 will be described with reference to the environment of FIG. 1. In the application environment 110, the digital assistant may be evaluated by electronic device 110.

At block 201, the electronic device 110 obtains, in response to an evaluation request for the target digital assistant 121, at least one set of test cases for the target digital assistant 121, each set of test cases includes at least one test question related to a chat skill of the target digital assistant 121.

The evaluation request for the target digital assistant 121 may be various, for example, the target digital assistant 121 having launched for a certain period of time may be taken as the evaluation request, or an evaluation instruction from the developer may be taken as the evaluation request, or a number of feedbacks from the users may be taken as the evaluation request, and so on.

The test cases for the chat skill of the target digital assistant 121 may include a plurality of sets, and each set of test cases for the chat skill corresponds to different evaluation dimensions. The test cases for the chat skill may be generated based on prompt information. For example, the prompt information may include an identification of the target digital assistant 121, and the identification may be a name or a serial number. Additionally, the prompt information may further include a function description of the target digital assistant, for example, a brief introduction, a function profile, and an operating guide of the target digital assistant 121.

The brief introduction may describe the primary functions of the target digital assistant 121. By way of example, the brief introduction may include that the role of the digital assistant is a legal assistant that can answer various legal related questions.

The function profile may indicate services or functions that the target digital assistant 121 can provide. By way of example, the function profile may include that the digital assistant may provide a plurality of services such as legal consulting, legal document generation, legal fee calculation, legal education and so on to the user.

The operating guide may introduce an interaction mode of the target digital assistant 121. For example, the operating guide may include that a user may ask me about anything of interest related to law.

The evaluation dimensions may be preset. The different evaluation dimensions are used to evaluate different capabilities embodied by the chat skill of the digital assistant. In some embodiments, different evaluation dimensions may correspond to the identity cognition capability, the function cognition capability, the basic interaction capability, the interaction capability that is positively correlated with the domain of specialties, the interaction capability that is negatively correlated with the domain of specialties, the capability to handle abnormal interactions, and the like. It is to be understood that other evaluation dimensions and their corresponding abilities to be evaluated may also be defined according to specific evaluation requirements.

The test cases for the identity cognition capability may be used to evaluate the capability of the target digital assistant 121 to recognize and express its own identity. For example, the content of the function description contains that the target digital assistant 121 specializes in the field of law, then the test question may be “Who are you?” and so on to guide the target digital assistant 121 to answer who it is. Additionally, the test question may be “Is your role the conference host?” and similar questions that mislead the target digital assistant 121 about its identity.

The test cases for function cognition capability may be used to evaluate the description and understanding of the functions provided by the target digital assistant 121, for example, questions similar to “what can you do?” to guide the target digital assistant 121 to tell its functions.

The test cases for basic interaction capability may be used to evaluate the capability of the target digital assistant 121 to handle a general conversation, including understanding the user's intent, providing a reasonable response, and the like.

The test cases for interaction capability that is positively correlated to the domain of specialties may be used to evaluate the performance of the target digital assistant 121 in its domain of expertise, for example, the accuracy and expertise of the target digital assistant 121 in answering legal related questions.

The test cases for interaction capability that is negatively correlated to the domain of specialties may be used to evaluate the performance of the target digital assistant 121 in a domain of non-specialties, to ensure that it can reasonably guide the user or recognize its own limitations.

The test cases for the capability of handling the abnormal interaction may be used to simulate various abnormal situations or misoperations, and evaluate how the digital assistant handles the unexpected input or the abnormal request from the user.

For a given set of test cases for the chat skill, at least one round of interaction test related to a given evaluation dimension may be determined. For example, if the content of the function description contains that the target digital assistant specializes in the field of law, the test cases for the identity cognition capability may include at least two rounds of interaction test. The test question of the first round of interaction test may be “Who are you?” and so on to guide the target digital assistant 121 to answer who it is. The test question of the second round of interaction test may further be “Is your role the conference host?” and similar questions that mislead the target digital assistant 121 about its identity.

At block 202, the electronic device 110 provides the at least one set of test cases to the target digital assistant 121 to obtain a reply to the at least one set of test cases by the target digital assistant 121. Based on these replies, the electronic device 110 may evaluate the performance and capabilities of the target digital assistant 121 in different contexts in the subsequent process.

At block 203, the electronic device 110 determines a target evaluation index for the target digital assistant 121 based at least on the at least one set of test cases and the reply to the at least one set of test cases by the target digital assistant 121. In the embodiments of the present disclosure, the target evaluation index includes at least a first feature value indicating a chat skill score of the target digital assistant.

If a plurality of sets of test cases are to be used to test the target digital assistant 121, and each set of test cases further includes at least one test question, replies of the target digital assistant 121 to different test questions may be obtained. For the chat skill scores corresponding to the plurality of replies, the first feature value of the chat skill score of the target digital assistant 121 may be obtained by averaging, weighted averaging, and the like.

As described above, the target evaluation index may indicate a first feature value of the chat skill score of the target digital assistant 121. Additionally, the target evaluation index may further indicate feature values of different scores, such as, the response speed, the fluency of the language stream, and the personalization degree of the reply content of the target digital assistant 121.

At block 204, the electronic device 110 determines a quality evaluation result of the target digital assistant 121 based on the target evaluation index. The electronic device 110 may set corresponding weights for different target evaluation indexes. The weights may reflect the importance of each target evaluation index in the overall evaluation. For example, for a digital assistant, its identity cognition, function cognition, and knowledge interactions in the domain of specialties may be given higher weights. Through this weighting process, the electronic device 110 can generate a comprehensive evaluation result, which accurately reflects the overall performance of the target digital assistant 121.

Through the evaluation method described above, the limitation that a digital assistant is tested and recommended by an operator manually in the prior art can be solved. The automated evaluation process not only improves the efficiency but also ensures the objectivity and consistency of the evaluation. This not only enhances user experience, ensures that the recommended digital assistant satisfies the user's need, but also provides developers with feedbacks for improving the product.

As previously described, the evaluation of the digital assistant is implemented based on test cases. The obtaining manner of the test cases is described in detail below. In some embodiments of the present disclosure, the electronic device 110 obtains prompt word information of the target digital assistant 121, and the prompt word information includes at least identification information and a function description of the target digital assistant 121, obtains a universal question generation rule corresponding to each set of test cases in the at least one set of test cases, and generates one or more sets of test cases for the target digital assistant 121 based at least on the prompt word information and the universal question generation rule.

The prompt information of the target digital assistant 121 includes at least identification information and a function description of the target digital assistant 121. The identification information is used to uniquely identify the target digital assistant 121, for example, the name, the serial number, etc. of the target digital assistant 121. The function description is used to describe main functions and features of the target digital assistant 121, for example, information describing a developer, a domain at which the target digital assistant 121 specializes, a type of conversation supported, and the like.

The universal question generation rule may be a set of universal criteria and guidelines for creating a test case. These rules ensure that the generated test case is related to the prompt information of the target digital assistant 121 and can effectively test its functions and performance.

By way of example, the universal question generation rule includes the following: in the process of generating the test cases, it is ensured that the generated test case is related to the prompt information of the digital assistant. The generated test case must conform to a predefined rule. In a case where generating the test case includes multiple rounds of interactions, it is necessary to continue the existing topic, rather than introducing a new topic, to ensure the coherence of multiple rounds of interactions. Only the generated test case is output. No other content is output. The test cases must be in plain text format. The generated test cases should not contain reply content to the digital assistant. Only one test case is generated at a time. If there are multiple rounds of interaction, the next test case is generated in combination with the reply of the digital assistant. Previous test cases are avoided to be repeated, and uniqueness and continuity of the conversation are maintained.

The electronic device 110 may generate one or more sets of test cases by a test case generation model. The prompt word information and the universal question generation rule of the target digital assistant 121 may be used as input information of the test case generation model, and reply content of the model is generated by using the test case. By generating the reply content of the model based on the test case, one or more sets of test cases for the target digital assistant 121 may be obtained.

Additionally, the input information of the test case generation model may include a role description of the test case generation model. For example, the role description may be: you are a digital assistant for generating a chat test case. Your task is to generate a test case according to the prompt information of the target digital assistant.

In the embodiments of the present application, an example implementation of generating input information is described in a Chinese language environment. Alternatively and/or additionally, a corresponding solution for generating input information may be implemented in other language environments. For example, the input information may be generated in an environment of, such as, Chinese, English, Japanese, French and so on. For example, the input information for the test case generation model may be generated in application environments in different languages based on the multi-language capability provided by the test case generation model.

In this way, the electronic device 110 can systematically generate a plurality of sets of test cases, and provides a comprehensive and effective tool for evaluation and optimization of the digital assistant.

Another approach may be provided for obtaining the test case. The electronic device 110 obtains prompt word information of the target digital assistant 121, and the prompt word information includes at least identification information and a function description of the target digital assistant 121. At least one specific question generation rule corresponding to each of the at least one evaluation dimension is determined based on at least one evaluation dimension related to the chat skill. One or more sets of test cases for the target digital assistant 121 are generated based at least on the prompt word information and the at least one specific question generation rule.

The prompt word information of the target digital assistant 121 is the same as in the example as described above, and details are not repeated herein. The evaluation dimension related to the chat skill may include an identity cognition capability, a function cognition capability, a basic interaction capability, an interaction capability that is positively correlated with the domain of specialties, an interaction capability that is negatively correlated with the domain of specialties, a capability to handle abnormal interactions, and the like.

In an example of the evaluation dimension corresponding to the identity cognition capability, the specific question generation rule may include: generating an identity awareness test case according to the prompt information of the target digital assistant, and guiding the target digital assistant to tell who it is. Additionally, it is also necessary to mislead the target digital assistant about its identity. The number of rounds of the interaction test is 2 rounds.

In an example of the evaluation dimension corresponding to the function cognition capability, the specific question generation rule may include: generating a function test case according to the prompt information of the target digital assistant. The target digital assistant is guided to tell its function. The number of rounds of the interaction test is 1 round.

In an example of the evaluation dimension corresponding to the basic interaction capability, the specific question generation rule may include: generating a chat test case that is not related to the domain of specialties of the target digital assistant according to the prompt information of the target digital assistant. The number of rounds of the interaction test is 1 round.

In an example of the evaluation dimension corresponding to the interaction capability that is positively correlated to the domain of specialties, the specific question generation rule may include: generating a test case that is positively correlated with the domain of specialties according to the prompt information of the target digital assistant. The test case that is positively correlated with the domain of specialties covers all functions of the target digital assistant. The input of true and false information needs to be considered. The test case that is positively correlated to the domain of specialties should not only query whether the target digital assistant can do something, but rather have the target digital assistant actually do it. The generated test question that is positively correlated to the domain of specialties should not be independent of each other. They should continue the previous topic to go deep into chat according to the chat history. Only generating test questions are performed without outputting any information. The number of rounds of the interaction test is 5 rounds.

In an example of the evaluation dimension corresponding to the interaction capability that is negatively correlated to the domain of specialties, the specific question generation rule may include: generating a function test that is completely unrelated to the domain of specialties of the target digital assistant according to the prompt information of the target digital assistant. The test case that is negatively correlated to the domain of specialties should not only query whether the target digital assistant can do something that is completely unrelated to the domain of specialties of the target digital assistant, but rather have the target digital assistant actually do it. The number of rounds of the interaction test is 2 rounds.

In an example of the evaluation dimension corresponding to the capability of handling abnormal interaction, the specific question generation rule may include: generating the abnormal interaction test case according to the prompt information of the target digital assistant. For example, if the target digital assistant requires input of an picture, content that is not related to the picture should be input, such as inputting text or audio. The number of round of the interaction test is 1 round.

The electronic device 110 may generate one or more sets of test cases based on the test case generation model. The prompt word information of the target digital assistant 121 and the specific question generation rule may be used as input information of the test case generation model, and generate one or more sets of test cases for the target digital assistant 121 based on the reply content of the test case generation model.

Through the above process, a test case can be generated based on a plurality of evaluation dimensions, thereby comprehensively evaluating various capabilities of the target digital assistant 121. Specifically, the evaluation content includes an identity cognition capability, a function cognition capability, a basic interaction capability, an interaction capability that is positively correlated with the domain of specialties, an interaction capability that is negatively correlated with the domain of specialties, a capability of handling abnormal interactions, and the like. The method not only can evaluate the actual chat skill of the target digital assistant 121, but also can identify the performance of the target digital assistant 121 under different contexts, thereby providing a reliable basis for recommending high-quality digital assistants.

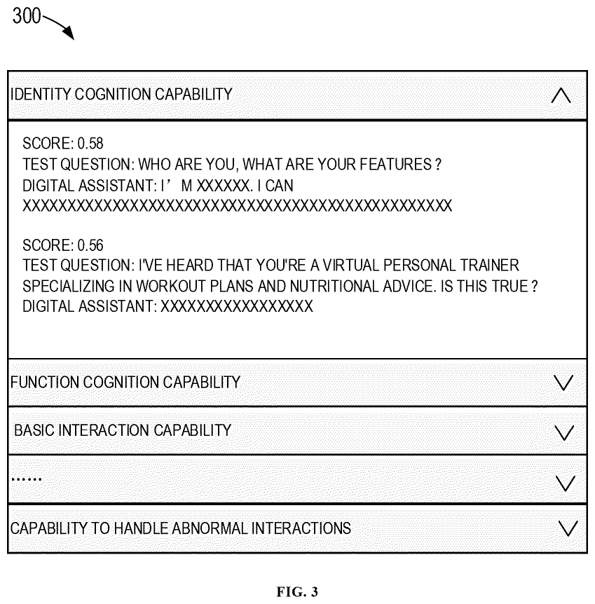

By way of example, the first feature value includes a chat skill score corresponding to each of the at least one evaluation dimension. FIG. 3 illustrates a schematic diagram of a chat skill score interface 300 according to some embodiments of the present disclosure. As shown in FIG. 3, for the test question for evaluation dimension, the target digital assistant 121 may generate a corresponding reply. The scoring model may be utilized to generate a chat skill score for each reply. For example, in FIG. 3, the evaluation dimension corresponding to the identity cognition capability includes 2 test questions, and the chat skill score of the first test question is 0.58. The chat skill score of the second test question is 0.56. Similarly, the chat skill scores corresponding to the test questions of the dimensions such as a function cognition capability, a basic interaction capability, a positive function interaction capability, a negative function interaction capability, an abnormal handling capability and so on may be further referenced.

In some embodiments, the first feature value in the target evaluation index may include an aggregated value of the chat skill score of each of the evaluation dimensions. For example, an average of the chat skill scores corresponding to respective evaluation dimensions may be calculated as the first feature value.

For the case of multiple rounds of interaction that may occur in a given evaluation dimension, the generation process of the test question is different from the example described above. In the following, an evaluation dimension corresponding to the interaction capability that is positively correlated to the domain of specialties is given as an example, in which a number of rounds of interaction test in the set of test cases is 5 rounds. For a scenario of multiple rounds of interaction, the electronic device 110 obtains a first reply for a first test question by the target digital assistant 121 in a first round of interaction with the target digital assistant 121. A second test question for a second round of interaction with the target digital assistant 121 is generated based at least on the first reply.

The evaluation of the interaction capability of the digital assistant that is positively correlated to the domain of specialties requires multiple rounds of interaction test. This is to fully test the capability of the digital assistant to handle complex dialogs within its domain of specialties. Taking the first round of interaction as an example, the electronic device 110 generates the first test question by the test case generation model based on the prompt word information and the corresponding specific question generation rule as the input information. Based on the first reply to the first test question by the target digital assistant 121, the electronic device 110 may generate the second test question associated with the first reply by the test case generation model. For example, if the first reply refers to a “breach clause” in a contract, the second question may be “can you explain in detail the specific content of the breach clause and how it applies in the present case?”

The above process may be repeated in subsequence rounds of interaction. The electronic device 110 performs a third round, a fourth round, and a fifth round of interaction in sequence. The test question in Each round is generated based at least on the reply in the previous round, which ensures consistency and depth of the test conversation. For example, a test question in the third round of interaction may deeply discuss legal consequences of the breach clause. The test question in the fourth round of interaction may discuss how to protect its own rights in the contract. The test question in the fifth round of interaction may ask about the application of breach clause in actual cases.

Through such multiple rounds of interaction test, the electronic device 110 can comprehensively evaluate the capability of the digital assistant to handle complex dialogs. The test question and reply in each round are based on content in the previous round and simulates a real user interaction scenario. This testing method not only examines the knowledge depth and response accuracy of the target digital assistant 121, but also evaluates its capability to maintain logic consistency and provide valuable information in a continuous dialog. Ultimately, these test results will be used as important index to evaluate the capability of the digital assistant, which help the developer 105 to identify and improve the interactive performance in particular domains.

In the foregoing embodiments, the target evaluation index reflecting the chat skill of the target digital assistant 121 is given as an example. Here, in addition to indicating the chat skill of the target digital assistant, the target evaluation index may also be determined based on configuration information of the target digital assistant 121. In some embodiments of the present disclosure, the electronic device 110 determines at least one second feature value for the target digital assistant 121 in the target evaluation index based on the configuration information of the target digital assistant 121, the target digital assistant 121 generates and presents a reply based on the configuration information, and each second feature value indicates a score of the target digital assistant 121 on a configuration type.

The digital assistant may be developed based on the digital assistant development platform 120. The digital assistant development platform 120 may provide various tools, such as prompt word information, plug-ins, workflows, knowledge bases, memory banks, voice, and the like. Based on this, the configuration information may reflect tools involved in the development process of the target digital assistant 121. Each tool may correspond to a configuration type.

By way of example, the second feature value may include a score of the target digital assistant 121 on the configuration type. For example, the score on the configuration type may indicate the number of sounds supported by the digital assistant, the number of recommended conversations, the number of workflows, the number of plug-ins, the number of knowledge bases, the number of publishing platforms, whether there is a background image, the number of memory banks, the number of bound cards, whether or not it is open source, and so on.

The number of supported voices may indicate the number of voice options supported by the target digital assistant 121, such as the number of male voices, female voices, children's voices, and so on. Providing a variety of voice options may increase the user satisfaction and engagement.

The number of recommended conversations may indicate the number of conversations that the target digital assistant 121 may recommend to the user, that is, to indicate how many conversational topics or subjects (related to the user's interests, requirements, historical conversation records, and so on) the target digital assistant 121 may provide or recommend for the user to select from and to continue to interact with.

The number of workflows may indicate the number of workflows that the target digital assistant 121 has. More workflows may implement more complex tasks and automated operations.

The number of plug-ins may indicate the number of plug-ins that the target digital assistant 121 may integrate. By integrating the plug-ins, the target digital assistant 121 can expand its functionality to provide more services and applications.

The number of knowledge bases may indicate the number of knowledge bases that the target digital assistant 121 may access and utilize. A rich knowledge base can improve the answering accuracy and the information coverage of the digital assistant.

The number of publishing platforms may indicate how many platforms on which the target digital assistant 121 may publish. The capability to publish on multiple platforms can expand the user group of the digital assistant, and improve the popularity and usage rate thereof.

Whether there is a background image may indicate whether the target digital assistant 121 has a background image function. The background image may enhance the visual appeal and improve the user's interface experience.

The number of memory banks may indicate the number of memory banks to which the target digital assistant 121 is associated. The memory banks may be used at least to record historical dialogues of a user, and provide personalized services and ongoing conversation context.

Whether it is open source may indicate whether the target digital assistant 121 supports the code open-source project. If so, the development and improvement of digital assistants can be accelerated more conveniently.

Additionally, the second feature value may further include an evaluation score for the prompt information of the target digital assistant 121. For example, the prompt information of the target digital assistant 121 may be input to a model having a natural language evaluation function, and a corresponding evaluation score is given by the model having a natural language evaluation function.

In evaluating the target digital assistant 121, the scores of the digital assistant on the different configuration types may be used as the evaluation indexes. Thus, a comprehensive evaluation framework may be provided for the target digital assistant 121. The user is helped to identify high-quality and reliable digital assistants, so that the requirements of users are better satisfied.

In addition to being based on the configuration information of the target digital assistant 121, the target evaluation index may be determined based on historical interaction information related to the target digital assistant 121. In some embodiments of the present disclosure, the electronic device 110 determines at least one third feature value for the target digital assistant 121 in the target evaluation index based on historical interaction information related to the target digital assistant 121, and each third feature value indicates a score of the target digital assistant 121 on a user interaction type.

The historical interaction information may reflect real-time performance of the target digital assistant 121 and interaction with the user 135. For example, the historical interaction information includes at least one of the following: a number of users that interact with the target digital assistant 121 over a period of time, the number of messages for interacting with the target digital assistant 121 over a period of time, the number of at least one type of interaction behavior performed on the target digital assistant 121.

The dynamic features corresponding to the historical interaction information may be included in the evaluation index, for example, the user engagement and the interaction quantity of the digital assistant in a specific period of time may be evaluated by the number of active users and the number of chat messages over a period of time. The degree of user recognition and satisfaction on the digital assistant may be understood through the number of collections, the number of likes and the number of dislikes. Therefore, the performance of the digital assistant during actual use and user feedback can be fully understood. The static features corresponding to the configuration information reflect the design and configuration of the digital assistant, while the dynamic features corresponding to the historical interaction information provide the interaction data of the digital assistant in actual use of the user. By combining these two types of features, the advantages and disadvantages of the target digital assistant 121 can be evaluated from multiple dimensions.

In order to improve the automation of the quality evaluation result to ensure the unified scale of the standard evaluation result, the quality evaluation result of the target digital assistant 121 is determined based on the target evaluation index by the trained evaluation model. The quality evaluation result indicates the confidence that the target digital assistant is recommended, and the evaluation model is trained by obtaining a first evaluation index of a digital assistant that has been recommended as the positive sample, obtaining a second evaluation index of a digital assistant that is not recommended as a negative sample; and training the evaluation model with the positive and negative samples.

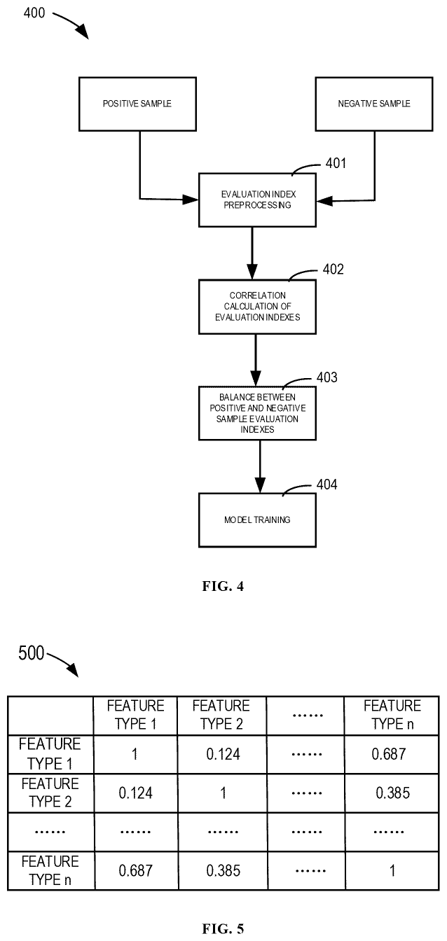

FIG. 4 illustrates a schematic diagram of a training process 400 of an evaluation model according to some embodiments of the present disclosure. A first evaluation index of a digital assistant that has been recommended is obtained as a positive sample, and a second evaluation index of a digital assistant that is not recommended is obtained as a negative sample.

At block 401, pre-processing is performed first on the evaluation indexes in the positive and negative samples. Since the first evaluation index and the second evaluation index respectively include feature values corresponding to a plurality of feature types, and the value ranges of different feature values may vary widely. For example, if the feature type is the number of active users or chat messages over a period of time, the corresponding feature values may be hundreds or thousands, or even tens of thousands. For example, the feature type of knowledge base usually has a single-digit number, and a chat skill score, for example, is only between 0 and 1. Therefore, the feature values corresponding to all evaluation indexes need to be converted into the same range of values by pre-processing.

At block 402, correlation calculations need to be performed on the evaluation indexes. That is, if the first evaluation index and the second evaluation index respectively include feature values corresponding to the plurality of feature types, then the correlation between the plurality of feature types in the first evaluation index and the second evaluation index may be determined. At least one feature type to be included in the target evaluation index is selected from the plurality of feature types based on the correlation between the plurality of feature types.

FIG. 5 illustrates a schematic diagram of a correlation distribution 500 according to some embodiments of the present disclosure. Each feature type in the first evaluation index and the second evaluation index is obtained, which is represented as feature type 1 to feature type n in FIG. 5 respectively (n is a positive integer). By calculating, a correlation distribution among the plurality of feature types may be determined. Based on the result of the correlation distribution, a tradeoff is performed on the feature types. For example, if the correlation between two feature types is high, it may lead to multicolinearity problems, affecting the stability and interpretability of the model. In this case, one of the feature types may be selected to be discarded. For another example, if the feature type i is determined to be a key feature, the correlation between the feature type 1 and the feature type i (i≤n, and i is a positive integer) is 0.35, and the correlation between the feature type 2 and the feature type i is 0.8, the feature type 1 may also be selected to be discarded while the feature type 2 is retained based on the importance degree of the feature type.

Based on the correlation between the feature types, at least one feature type to be included in the target evaluation index may be selected from the plurality of feature types. The selected feature type may be a feature type that has a more obvious influence on the evaluation effect.

At block 403, a certain number of samples are randomly selected from the positive and negative samples to ensure a balance between the number of positive samples and the number of negative samples used for model training. For example, first evaluation indexes of 2000 digital assistants that have been recommended may be selected as the positive samples, and second evaluation indexes of 2000 digital assistants may be selected randomly from 10000 digital assistants that are not recommended.

At block 404, training of the evaluation model is performed. During the training of the evaluation model, logistic regression may be first defined as the classification algorithm of the evaluation model. This step determines the basic structure of the evaluation model, that is, using logistic regression to solve a binary classification problem (recommended or not recommended). Training the evaluation model by using the prepared training data may indicate an importance level of the target evaluation index. For example, the target digital assistant 121 includes 10 target evaluation indexes, and calculating a final score based on the importance level of the target evaluation indexes determined by the evaluation model can determine whether or not the target digital assistant 121 is worthy of being recommended. For example, the final score may be a numerical value in the range of 0 to 1. For example, a numerical value such as 0.5 or 0.75 may be used as a threshold. If it is above the threshold, the evaluation model may yield a result that it is worthy of being recommended. This results in a classification function.

Through the above process, the evaluation model can effectively learn based on the evaluation indexes of the recommended and unrecommended digital assistants, and accurately predict a recommendation value of the new digital assistant. This not only improves the efficiency and accuracy of the recommendation system, but also provides users with a better choice of digital assistant.

With the trained evaluation model, a quality evaluation result of the target digital assistant 121 may be determined based on the target evaluation index. The quality evaluation result indicates a confidence that the target digital assistant 121 is recommended. In some embodiments of the present disclosure, the electronic device 110 displays the target digital assistant 121 on the recommendation interface in response to the quality evaluation result satisfying a recommendation condition. The recommendation effect index of the target digital assistant 121 after being recommended is obtained. The evaluation model is updated based on the recommendation effect index.

In a case where the quality evaluation result satisfies the preset recommendation condition (for example, the recommendation confidence is above a certain threshold), the electronic device 110 may display the target digital assistant 121 on the recommendation interface of the digital assistant recommendation platform 130. In this way, the user 135 can conveniently discover and use the recommended digital assistant, thereby improving the overall user experience.

After the target digital assistant 121 is recommended, the electronic device 110 may constantly monitor its recommendation effect indexes. These recommendation effect indexes may include, but are not limited to, the following aspects: user click rate, user retention rate, user satisfaction score, and frequency of use, and so on. The user click rate may indicate a ratio of the number of times the user clicks on the target digital assistant 121 on the recommendation interface to the number of times of display. The user retention rate may indicate a ratio of users who continue to use the target digital assistant 121 after using the assistant. The user satisfaction score may indicate a user's rating or feedback of the target digital assistant 121. The frequency of use may indicate a frequency of the user using the target digital assistant 121 over a period of time.

Based on the collected recommendation effect indexes, the electronic device 110 periodically updates the evaluation model. Such a process includes: collecting recommendation effect index data of the target digital assistant 121 after being recommended, analyzing the data, and evaluating the prediction accuracy and effectiveness of the current evaluation model. The parameters of the evaluation model are adjusted according to the analysis result. The specific steps may include adding new features, adjusting weights of existing features, optimizing hyperparameters of the model, and the like. The evaluation model is retrained with the updated dataset to ensure that it still performs well in the new data environment. Model deployment: deploying the updated evaluation model in the system to replace the old model, so that the new model can be used in the subsequent recommendation process.

By continuously obtaining and analyzing the recommendation effect index, the electronic device 110 may constantly improve the evaluation model, thereby improving the recommendation accuracy and user experience, and eventually implementing a more intelligent and personalized digital assistant recommendation system.

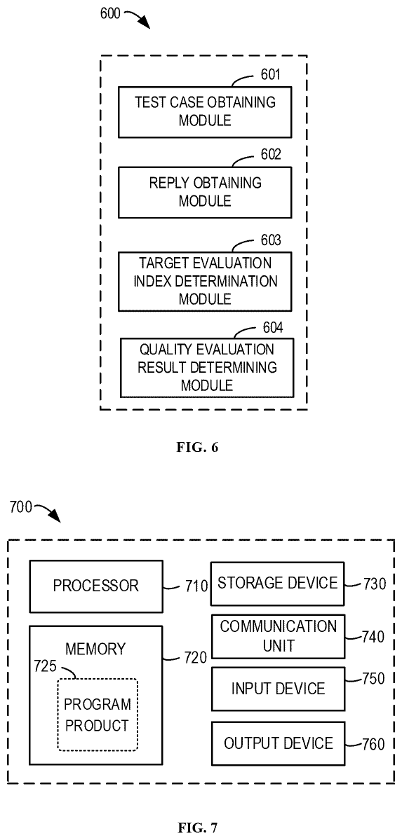

FIG. 6 illustrates a schematic structural block diagram of an apparatus 600 for evaluating a digital assistant in accordance with some embodiments of the present disclosure. The apparatus 600 may be, for example, implemented in or included in the electronic device 110. Various modules/components in the apparatus 600 may be implemented by hardware, software, firmware, or any combination thereof.

As shown, the apparatus 600 includes a test case obtaining module 601 configured to obtain, in response to an evaluation request for a target digital assistant, at least one set of test cases for the target digital assistant, each set of test cases comprising at least one test question related to a chat skill of the target digital assistant. A reply obtaining module 602 is configured to provide the at least one set of test cases to the target digital assistant to obtain a reply to the at least one set of test cases by the target digital assistant. A target evaluation index determination module 603 is configured to determine a target evaluation index for the target digital assistant based at least on the at least one set of test cases and the reply to the at least one set of test cases by the target digital assistant, the target evaluation index comprising at least a first feature value indicating a chat skill score of the target digital assistant. A quality evaluation result determining module 604 is configured to determine a quality evaluation result of the target digital assistant based on the target evaluation index.

In some embodiments of the present disclosure, the test case obtaining module 601 may be specifically configured to obtain prompt word information of the target digital assistant, the prompt word information comprising at least identification information and a function description of the target digital assistant;
obtaining a universal question generation rule corresponding to each set of test cases in the at least one set of test cases; generating one or more sets of test cases for the target digital assistant based at least on the prompt word information and the universal question generation rule.

In some embodiments of the present disclosure, the test case obtaining module 601 may be further configured to obtain prompt word information of the target digital assistant, the prompt word information comprising at least identification information and a function description of the target digital assistant; determining, based on at least one evaluation dimension related to the chat skill, at least one specific question generation rule corresponding to each of the at least one evaluation dimension; and generating one or more sets of test cases for the target digital assistant based at least on the prompt word information and the at least one specific question generation rule.

In some embodiments of the present disclosure, the first feature value includes a chat skill score corresponding to each of the at least one evaluation dimension.

In some embodiments of the present disclosure, the test case obtaining module 601 may be further configured to obtain a first reply of the target digital assistant for a first test question in a first round of interaction with the target digital assistant; and generating a second test question for a second round of interaction of the target digital assistant based at least on the first reply.

In some embodiments of the present disclosure, the target evaluation index determination module 603 may be configured to determine at least one second feature value for the target digital assistant in the target evaluation index based on configuration information of the target digital assistant, and generating and presenting the reply based on the configuration information, and at least one second feature value indicating a score of the target digital assistant on a configuration type.

In some embodiments of the present disclosure, the target evaluation index determination module 603 may be further configured to determine at least one third feature value for the target digital assistant in the target evaluation index based on historical interaction information related to the target digital assistant, each third feature value indicating a score of the target digital assistant on a user interaction type.

In some embodiments of the present disclosure, the historical interaction information includes at least one of the following: a number of users that interact with the target digital assistant within a period of time, a number of messages for interacting with the target digital assistant within a period of time, or a number of at least one type of interaction behavior performed on the target digital assistant.

In some embodiments of the present disclosure, the quality evaluation result of the target digital assistant is determined by an evaluation model based on the target evaluation index.

In some embodiments of the present disclosure, a model training module is further included. A confidence that the target digital assistant is recommended is indicated based on the quality evaluation result. The training module is configured to obtain a first evaluation index of a digital assistant that has been recommended as a positive sample, obtain a second evaluation index of the digital assistant that is not recommended as a negative sample, and train the evaluation model with the positive sample and the negative sample.

In some embodiments of the present disclosure, the first evaluation index and the second evaluation index respectively include feature values corresponding to a plurality of feature types, and the model training module may be further configured to determine a correlation between the plurality of feature types in the first evaluation index and the second evaluation index, and select at least one feature type to be comprised in the target evaluation index from the plurality of feature types based on the correlation between the plurality of feature types.

In some embodiments of the present disclosure, the model training module may be further configured to display the target digital assistant on a recommendation interface in response to the quality evaluation result satisfying a recommendation condition, obtain a recommendation effect index of the target digital assistant after the target digital assistant is recommended, and update the evaluation model based on the recommendation effect index.

FIG. 7 illustrates a block diagram of an electronic device 700 in which one or more embodiments of the present disclosure may be implemented. It should be understood that the electronic device 700 in FIG. 7 is shown for merely illustrative purpose, and should not limit the functionality and scope of the embodiments described herein. The electronic device 700 shown in FIG. 7 may include or be implemented as the electronic device 110 in FIG. 1, or the apparatus 600 shown in FIG. 6.

As shown in FIG. 7, the electronic device 700 is in the form of a general-purpose computing device. The components of the electronic device 700 may include, but are not limited to, one or more processors or processing units 710, a memory 720, a storage device 730, one or more communications units 740, one or more input devices 750, and one or more output devices 760. The processor 710 may be a physical or virtual processor and can perform various processing according to a program stored in the memory 720. In a multiprocessor system, a plurality of processors executes computer executable instructions in parallel, so as to improve the parallel processing capability of the electronic device 700.

The electronic device 700 typically includes a plurality of computer storage medium. Such media may be any available media that are accessible by the electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a magnetic disk, or any other medium that can be used to store information and/or data and that can be accessed within the electronic device 700.

The electronic device 700 may further include additional detachable/undetachable, volatile/nonvolatile storage medium. Although not shown in FIG. 7, a magnetic disk drive for reading from or writing to a detachable, nonvolatile magnetic disk, such as a “floppy disk” and an optical disk drive for reading from or writing to a detachable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. Additionally, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown), such as a storage device, a display device, or the like through the communication unit 740 as desired, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which computer-executable instructions is stored, wherein the computer-executable instructions are executed by a processor to implement the method described above. According to an example implementation of the present disclosure, a computer program product is also provided, which is tangibly stored on a non-transitory computer readable medium and includes computer-executable instructions that are executed by a processor to implement the method described above.

According to example implementations of the present disclosure, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, to cause the computer device to perform the method provided in various optional modes in FIG. 2, and therefore, details are not described herein again.

Aspects of the present disclosure are described herein with reference to flowcharts and/or block diagrams of methods, apparatus, devices and computer program products implemented in accordance with the present disclosure. It should be understood that each block of the flowcharts and/or block diagrams and combinations of blocks in the flowchart and/or block diagrams can be implemented by computer readable program instructions.

These computer readable program instructions may be provided to a processor of a general-purpose computer, special purpose computer, or other programmable data processing apparatus to produce a machine, such that the instructions, when executed via the processor of the computer or other programmable data processing apparatus, create means for implementing the functions/actions specified in one or more blocks of the flowcharts and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture that includes instructions which implement various aspects of the functions/actions specified in one or more blocks of the flowcharts and/or block diagrams.

The computer readable program instructions may be loaded onto a computer, other programmable data processing apparatus, or other devices, causing a series of operational steps to be performed on the computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the present disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for evaluating a digital assistant, comprising:
obtaining, in response to an evaluation request for a target digital assistant, at least one set of test cases for the target digital assistant, each set of test cases comprising at least one test question related to a chat skill of the target digital assistant;
providing the at least one set of test cases to the target digital assistant to obtain a reply to the at least one set of test cases by the target digital assistant;
determining a target evaluation index for the target digital assistant based at least on the at least one set of test cases and the reply to the at least one set of test cases by the target digital assistant, the target evaluation index comprising at least a first feature value indicating a chat skill score of the target digital assistant; and
determining a quality evaluation result of the target digital assistant based on the target evaluation index.

2. The method of claim 1, wherein obtaining the at least one set of test cases for the target digital assistant comprises:
obtaining prompt word information of the target digital assistant, the prompt word information comprising at least identification information and a function description of the target digital assistant;
obtaining a universal question generation rule corresponding to each set of test cases in the at least one set of test cases; and
generating one or more sets of test cases for the target digital assistant based at least on the prompt word information and the universal question generation rule.

3. The method of claim 1, wherein obtaining the at least one set of test cases for the target digital assistant comprises:
obtaining prompt word information of the target digital assistant, the prompt word information comprising at least identification information and a function description of the target digital assistant;
determining, based on at least one evaluation dimension related to the chat skill, at least one specific question generation rule corresponding to each of the at least one evaluation dimension; and
generating one or more sets of test cases for the target digital assistant based at least on the prompt word information and the at least one specific question generation rule.

4. The method of claim 3, wherein the first feature value comprises a chat skill score corresponding to each of the at least one evaluation dimension.

5. The method of claim 1, wherein the method further comprises:
obtaining a first reply of the target digital assistant for a first test question in a first round of interaction with the target digital assistant; and
generating a second test question for a second round of interaction of the target digital assistant based at least on the first reply.

6. The method of claim 1, wherein determining the target evaluation index further comprises:
determining at least one second feature value for the target digital assistant in the target evaluation index based on configuration information of the target digital assistant, and
generating and presenting the reply based on the configuration information, the at least one second feature value indicating a score of the target digital assistant on a configuration type.

7. The method of claim 1, wherein determining the target evaluation index further comprises:
determining at least one third feature value for the target digital assistant in the target evaluation index based on historical interaction information related to the target digital assistant, each third feature value indicating a score of the target digital assistant on a user interaction type.

8. The method of claim 7, wherein the historical interaction information comprises at least one of the following:
a number of users that interact with the target digital assistant within a period of time;
a number of messages for interacting with the target digital assistant within a period of time; or
a number of at least one type of interaction behavior performed on the target digital assistant.

9. The method of claim 1, wherein the quality evaluation result of the target digital assistant is determined by an evaluation model based on the target evaluation index.

10. The method of claim 9, wherein the quality evaluation result indicates a confidence that the target digital assistant is recommended, and the evaluation model is trained by:
obtaining a first evaluation index of a digital assistant that has been recommended as a positive sample;
obtaining a second evaluation index of the digital assistant that is not recommended as a negative sample; and
training the evaluation model with the positive sample and the negative sample.

11. The method of claim 10, wherein the first evaluation index and the second evaluation index respectively comprise feature values corresponding to a plurality of feature types, and the method further comprises:
determining a correlation between the plurality of feature types in the first evaluation index and the second evaluation index; and
selecting at least one feature type to be comprised in the target evaluation index from the plurality of feature types based on the correlation between the plurality of feature types.

12. The method of claim 9, wherein the quality evaluation result indicates a confidence that the target digital assistant is recommended, and the method further comprises:
displaying the target digital assistant on a recommendation interface in response to the quality evaluation result satisfying a recommendation condition;
obtaining a recommendation effect index of the target digital assistant after the target digital assistant is recommended; and
updating the evaluation model based on the recommendation effect index.

13. An electronic device, comprising:
at least one processor; and
at least one memory coupled to the at least one processor and storing instructions for execution by the at least one processor, the instructions, when executed by the at least one processor, causing the electronic device to perform operations comprising:
obtaining, in response to an evaluation request for a target digital assistant, at least one set of test cases for the target digital assistant, each set of test cases comprising at least one test question related to a chat skill of the target digital assistant;
providing the at least one set of test cases to the target digital assistant to obtain a reply to the at least one set of test cases by the target digital assistant;
determining a target evaluation index for the target digital assistant based at least on the at least one set of test cases and the reply to the at least one set of test cases by the target digital assistant, the target evaluation index comprising at least a first feature value indicating a chat skill score of the target digital assistant; and
determining a quality evaluation result of the target digital assistant based on the target evaluation index.

14. The electronic device of claim 13, wherein obtaining the at least one set of test cases for the target digital assistant comprises:
obtaining prompt word information of the target digital assistant, the prompt word information comprising at least identification information and a function description of the target digital assistant;
obtaining a universal question generation rule corresponding to each set of test cases in the at least one set of test cases; and
generating one or more sets of test cases for the target digital assistant based at least on the prompt word information and the universal question generation rule.

15. The electronic device of claim 13, wherein obtaining the at least one set of test cases for the target digital assistant comprises:
obtaining prompt word information of the target digital assistant, the prompt word information comprising at least identification information and a function description of the target digital assistant;
determining, based on at least one evaluation dimension related to the chat skill, at least one specific question generation rule corresponding to each of the at least one evaluation dimension; and
generating one or more sets of test cases for the target digital assistant based at least on the prompt word information and the at least one specific question generation rule.

16. The electronic device of claim 15, wherein the first feature value comprises a chat skill score corresponding to each of the at least one evaluation dimension.

17. The electronic device of claim 13, wherein the operations further comprise:
obtaining a first reply of the target digital assistant for a first test question in a first round of interaction with the target digital assistant; and
generating a second test question for a second round of interaction of the target digital assistant based at least on the first reply.

18. The electronic device of claim 13, wherein determining the target evaluation index further comprises:
determining at least one second feature value for the target digital assistant in the target evaluation index based on configuration information of the target digital assistant, the target digital assistant generating and presenting the reply based on the configuration information, and each second feature value indicating a score of the target digital assistant on a configuration type.

19. A non-transitory computer-readable storage medium having stored thereon a computer program executable by a processor to implement operations comprising:
obtaining, in response to an evaluation request for a target digital assistant, at least one set of test cases for the target digital assistant, each set of test cases comprising at least one test question related to a chat skill of the target digital assistant;
providing the at least one set of test cases to the target digital assistant to obtain a reply to the at least one set of test cases by the target digital assistant;
determining a target evaluation index for the target digital assistant based at least on the at least one set of test cases and the reply to the at least one set of test cases by the target digital assistant, the target evaluation index comprising at least a first feature value indicating a chat skill score of the target digital assistant; and
determining a quality evaluation result of the target digital assistant based on the target evaluation index.

20. The non-transitory computer-readable storage medium of claim 19, wherein obtaining the at least one set of test cases for the target digital assistant comprises:
obtaining prompt word information of the target digital assistant, the prompt word information comprising at least identification information and a function description of the target digital assistant;
obtaining a universal question generation rule corresponding to each set of test cases in the at least one set of test cases; and
generating one or more sets of test cases for the target digital assistant based at least on the prompt word information and the universal question generation rule.
